(19) United States
(12) Patent Application Publication
(10) Pub. No.: US 2015/0298947 A1
(43) Pub. Date: Oct. 22, 2015

(54) GAS REGENERATION SYSTEM AND HYDRAULIC LIFT INCLUDING THE SAME

(71) Applicant: Snap-On Tools of Canada, Ltd., Mississauga (CA)

(72) Inventors: Neil A. Davis, Stockton, CA (US); Roy J. Dantas, Toronto (CA); Gary Diangelo, Mississauga (CA)

(21) Appl. No.: 14/688,599

(22) Filed: Apr. 16, 2015

Related U.S. Application Data
(60) Provisional application No. 61/980,257, filed on Apr. 16, 2014.

(51) Int. Cl. B66F 3/24; B66F 3/30; F15B 1/02; B66F 3/46

(52) U.S. Cl. CPC B66F 3/24; B66F 3/46; B66F 3/30; F15B 1/024

(57) ABSTRACT

A hydraulic lift is provided. The hydraulic lift may include a hydraulic cylinder defining a fluid chamber. The hydraulic cylinder may have a piston rod extending into the fluid chamber, a seal dividing the fluid chamber into a liquid chamber and a gas chamber, and a gas outlet from the gas chamber. The hydraulic lift may further include a pneumatic line in fluid communication with the gas outlet. The line may accumulate gas that is compressed in the gas chamber when the hydraulic cylinder is energized. The hydraulic lift may further include a load support for carrying a load and coupled to the hydraulic cylinder such that energizing the hydraulic cylinder raises the load support. The hydraulic lift is free of pneumatic tanks for compressed gas storage. A gas regeneration system and method of regenerating gas is also provided.

This application claims the benefit under 35 USC 119(e) of U.S. Provisional Application No. 61/980,257 filed Apr. 16, 2014.

### FIELD

The present disclosure relates to the field of gas regeneration systems and hydraulic lifts including the same.

### INTRODUCTION

Some hydraulic systems include one or more pneumatic devices. For example, a vehicle lift may include a vehicle support driven by hydraulic cylinders, and pneumatic safety locks to support a lifted vehicle when the hydraulic cylinders are not energized. Such hydraulic systems typically require a user to have a pressurized air supply to operate the one or more pneumatic devices.

### SUMMARY

In a first aspect, a hydraulic lift is provided. The hydraulic lift may include a hydraulic cylinder defining a fluid chamber. The hydraulic cylinder may have a piston rod extending into the fluid chamber, a seal dividing the fluid chamber into a liquid chamber and a gas chamber, and a gas outlet from the gas chamber. The hydraulic lift may also include a pneumatic line in fluid communication with the gas outlet. The line may accumulate gas that is compressed in the gas chamber when the hydraulic cylinder is energized. The hydraulic lift may also include a load support for carrying a load. The load support may be coupled to the hydraulic cylinder such that energizing the hydraulic cylinder raises the load support. The hydraulic lift may be free of pneumatic tanks for compressed gas storage.

In some embodiments, the hydraulic lift may include a pneumatic mechanical lock normally engaged to prevent the load support from lowering. The mechanical lock may be operable using the compressed gas accumulated in the line to disengage the mechanical lock.

In some embodiments, the hydraulic lift may include a valve fluidly coupled to the line and to the mechanical lock. The valve may be selectively fluidly coupling the line and the mechanical for providing compressed gas accumulated in the line to the mechanical lock to disengage the mechanical lock.

In some embodiments, the hydraulic lift may include a flow control device in communication with the line. The flow control device may prevent gas flow from the line into the gas chamber and permitting gas flow from the gas chamber into the line.

In some embodiments, the gas chamber may include a gas inlet, and the piston rod may be movable into or out of the fluid chamber to enlarge the gas chamber and draw gas into the gas chamber through the gas inlet.

In some embodiments, the hydraulic lift may include a flow control device in fluid communication with the gas inlet. The flow control device may prevent gas flow from the gas chamber through the gas inlet and permit gas flow through the gas inlet into the gas chamber.

In some embodiments, the hydraulic lift may include a second hydraulic cylinder defining a second fluid chamber. The second hydraulic cylinder may have a second piston rod extending into the second fluid chamber, a second seal dividing the second fluid chamber into a second liquid chamber and a second gas chamber, and a second gas outlet from the second gas chamber. The hydraulic lift may also include a second load support for carrying the load and coupled to the second hydraulic cylinder such that energizing the hydraulic cylinder raises the second load support. The line may be in fluid communication with the second gas outlet. The line may accumulate gas that is compressed in the second gas chamber when the second hydraulic cylinder is energized.

In another aspect, a gas regeneration system may be provided. The gas regeneration system may include a hydraulic cylinder defining a fluid chamber. The hydraulic cylinder may have a piston rod extending into the fluid chamber, a seal dividing the fluid chamber into a liquid chamber and a gas chamber, and a gas outlet from the gas chamber. The system may also include a pneumatic line in fluid communication with the gas outlet. The line may accumulate gas that is compressed in the gas chamber when the hydraulic cylinder is energized. The system may operate without a pneumatic tank for compressed gas storage.

In some embodiment, the system may further include a pneumatic device in fluid communication with the line for receiving the compressed gas accumulated in the line.

In some embodiments, the seal may be connected to the piston rod.

In some embodiments, the system may further include a flow control device in communication with the line. The flow control device may prevent gas flow from the line into the gas chamber and permitting gas flow from the gas chamber into the line.

In some embodiments, the system may further include a valve fluidly coupled to the line and a pneumatic device. The valve may be selectively fluidly coupling the line and the pneumatic device for providing compressed gas accumulated in the line to the pneumatic device.

In some embodiments, energizing the hydraulic cylinder may move the piston rod and decreases the volume of the gas chamber, which compresses the gas in the gas chamber and induces the compressed gas to flow through the gas outlet into the line.

In some embodiments, the gas chamber may include a gas inlet, and the piston rod may be movable into or out of the fluid chamber to enlarge the gas chamber and draw gas into the gas chamber through the gas inlet.

In some embodiments, the system may further include a flow control device in fluid communication with the gas inlet. The flow control device may prevent gas flow from the gas chamber through the gas inlet and permitting gas flow through the gas inlet into the gas chamber.

In some embodiments, the system may further include a second hydraulic cylinder defining a second fluid chamber. The second hydraulic cylinder may have a second piston rod extending into the second fluid chamber, a second seal dividing the second fluid chamber into a second liquid chamber and a second gas chamber, and a second gas outlet from the second gas chamber. The line may be in fluid communication with the second gas outlet. The line may accumulate gas that is compressed in the second gas chamber when the second hydraulic cylinder is energized.

In some embodiments, the pneumatic device may be a pneumatically actuated mechanical lock.

In another aspect, a method of regenerating gas from a hydraulic cylinder may be provided. The hydraulic cylinder may define a fluid chamber, and the hydraulic cylinder may have a seal dividing the fluid chamber into a liquid chamber and a gas chamber. The method may include energizing the hydraulic cylinder; accumulating gas in a pneumatic line that is compressed in the gas chamber when the hydraulic cylinder is energized; and providing the compressed gas accumulated in the line to a pneumatic device, the compressed gas never having been stored in a pneumatic tank.

In some embodiments, the method may further include drawing gas into the gas chamber through a gas inlet in the gas chamber.

In some embodiments, providing the compressed gas accumulated in the line to a pneumatic device comprises providing the compressed gas accumulated in the line to a pneumatic mechanical lock to disengage the mechanical lock.

### DRAWINGS

FIG. 1 shows a perspective view of a hydraulic lift, in accordance with at least one embodiment;

FIG. 2 shows an enlarged view of region 2 of FIG. 1;

FIG. 3 shows a schematic of the hydraulic lift of FIG. 1;

FIG. 4 shows a partial perspective view of the hydraulic lift of FIG. 1,

FIG. 5 shows an enlarged view of region 5 in FIG. 4;

FIG. 6 shows an enlarged view of region 6 in FIG. 4;

FIG. 7 shows an enlarged view of region 7 in FIG. 4;

FIG. 8 shows an enlarged view of region 8 in FIG. 4;

FIG. 9 shows an enlarged view of region 9 in FIG. 4; and

FIG. 10 shows an enlarged view of region 10 in FIG. 4.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

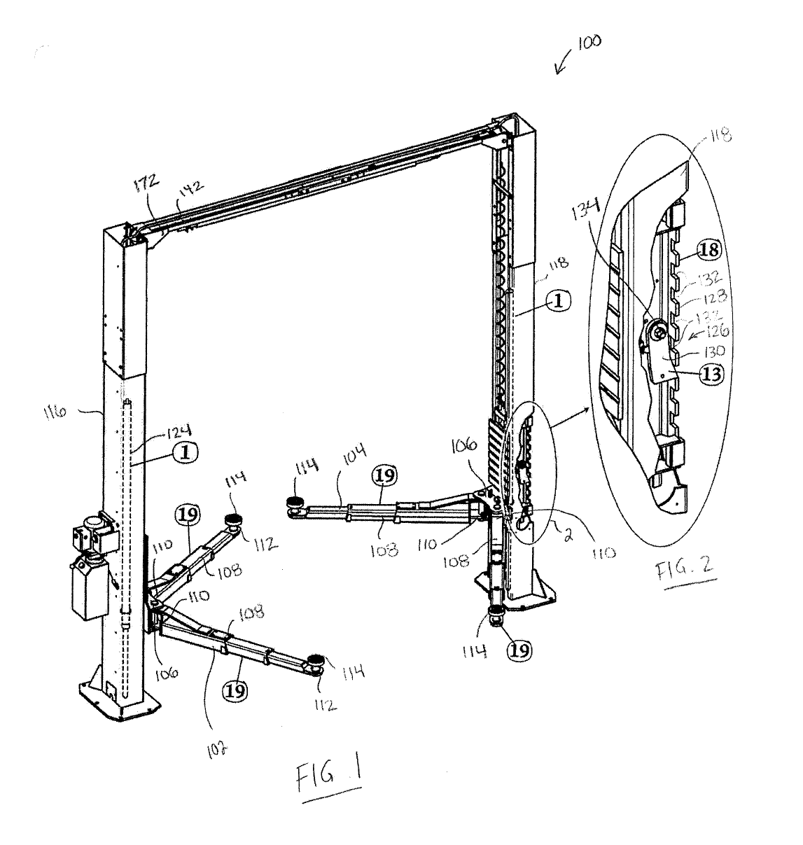

FIG. 1 shows a perspective view of a hydraulic lift 100, in accordance with at least one embodiment. Lift 100 may be configured to carry a load, such as a vehicle, a shipping container, or another object. In the example shown, hydraulic lift 100 includes load supports 102 and 104. As shown, each load support 102 and 104 includes a base 106 and two extensible arms 108. Each extensible arm 108 extends in length from a proximal end 110, which is pivotally mounted to base 106, to a distal end 112. A support surface 114 for supporting a load is connected to distal end 112 of each arm 108. In use, support surfaces 114 may be selectively positioned by extending or retracting arms 108, and by pivoting arms 108 about base 106.

Load supports 102 and 104 may be alternatively configured in any manner suitable for supporting a load. For example, load supports 102 and 104 may include a fewer or greater number of arms 108 (e.g. one, three, four or more arms), one or more of arms 108 may not be extensible, one or more of arms 108 may be rigidly connected or integrally formed with base 106, and/or one or more of arms 108 may extend vertically or at an angle instead of horizontally. In some embodiments, a support surface 114 (e.g. a platform) alone may comprise a load support. Although the example shown includes two load supports 102 and 104, lift 100 may alternatively include a fewer or greater number of load supports, such as one, three, four or more load supports.

Lift 100 may be configured to raise and lower load supports 102 and 104 to adjust the height of a carried load. For example, lift 100 may be a vehicle lift for raising a vehicle to provide convenient access to the underside of the vehicle or for storage. Each vertical column 116 and 118 is securely fastened or balanced on a surface below (not shown). In the example shown, each vertical column 116 and 118 includes a base 120 with mounting holes 122 for receiving fasteners (not shown) for anchoring base 120 to a floor below. Alternatively or in addition, bases 120 may be sized and positioned to balance vertical columns 116 and 118 without anchoring to a floor.

A hydraulic cylinder 124 is associated with each load support 102 and 104 for raising and lowering load supports 102 and 104. In the example shown, a stationary portion of each hydraulic cylinder 124 is connected one of vertical columns 116 and 118 and a mobile portion of each hydraulic cylinder is connected to one of load supports 102 and 104. In operation, energizing hydraulic cylinders 124 raises load supports 102 and 104 with the carried load. Each of load supports 102 and 104 is slideably connected to one of vertical columns 116 and 118. Load supports 102 and 104 slide along vertical columns 116 and 118 as load supports 102 and 104 are raised and lowered.

Although lift 100 is shown including two vertical columns 116 and 118, in alternative embodiments lift 100 may include a fewer or greater number of vertical columns, such as one, three, four or more vertical columns.

In alternative embodiments, lift 100 may not include vertical columns 116 and 118. For example, load supports 102 and 104 may be supported by hydraulic cylinders 124 alone. In some embodiments, an integral portion of each hydraulic cylinder 124 may comprise a load support. For example, a connecting ring, platform, or any other surface or portion of hydraulic cylinder 124, whether discretely connected or integral therewith, which can transfer force to a load upon energizing hydraulic cylinder 124 may comprise a load support for supporting a load.

Hydraulic cylinders 124 may be single-acting cylinders that are energized to raise a carried load, and de-energized to allow the carried load to lower by gravity (e.g. under the weight of the carried load and/or load supports 102 and 104). In the example shown, lift 100 is configured to selectively disrupt the descent of load supports 102, 104 (and the carried load) when hydraulic cylinders 124 are not energized. FIG. 2 shows an enlarged view of region 2 of FIG. 1. In the example shown, lift 100 include pneumatic mechanical locks 126. As discussed in more detail below, lift 100 includes a gas regeneration system, comprising hydraulic cylinders 124, which generates and stores the compressed gas required to operate pneumatic mechanical locks 126 (and/or other pneumatic devices) and which does not require a compressor to generate the compressed gas or a pneumatic tank to store the compressed gas.

As shown, pneumatic mechanical lock 126 includes a stationary rack 128 and a mobile ratchet 130 biased to normally engage with rack 128. Ratchet 130 is free to move upwardly and engage with slots 132 of rack 128 in sequence. However, ratchet 130 cannot move downwardly below the last engaged slot 132 unless ratchet 130 is released (i.e. mechanical lock 126 is disengaged). Support column 116 also include a similar pneumatic mechanical lock 126 (obstructed from view).

Ratchet 130 is shown connected to load support 104 such that ratchet 130 rises and lowers with load support 104. Energizing hydraulic cylinder 124 raises both of load support 104 and ratchet 130. When raised, ratchet 130 moves relative to rack 128 and sequentially engages slots 132 of rack 128. When hydraulic cylinders 124 are denergized, ratchet 130 remains locked to the last engage slot 132 of rack 128 and prevents load support 104 from lowering.

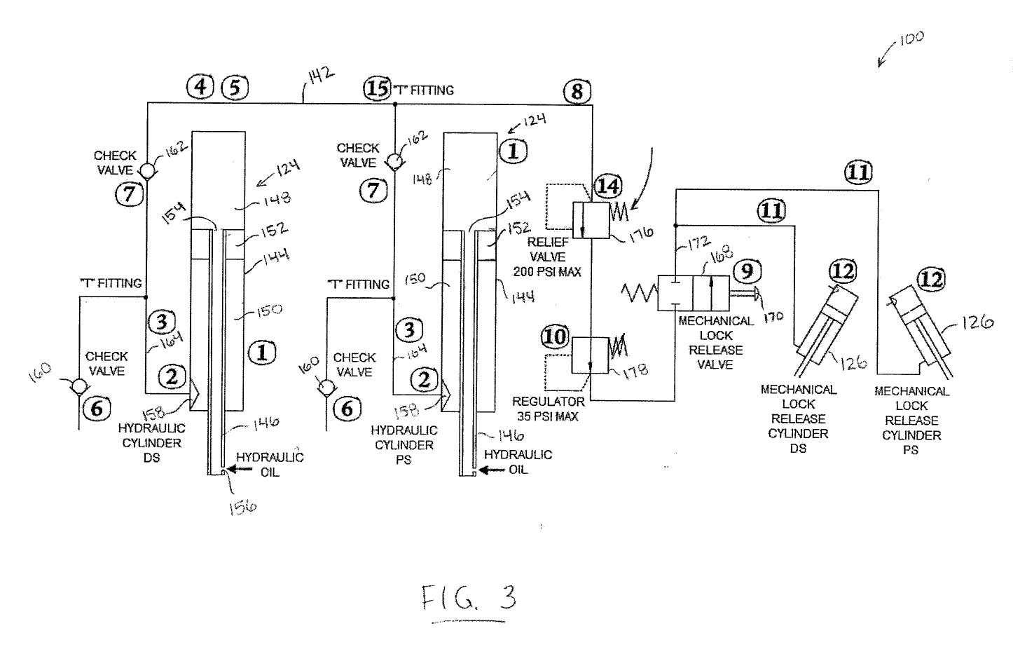

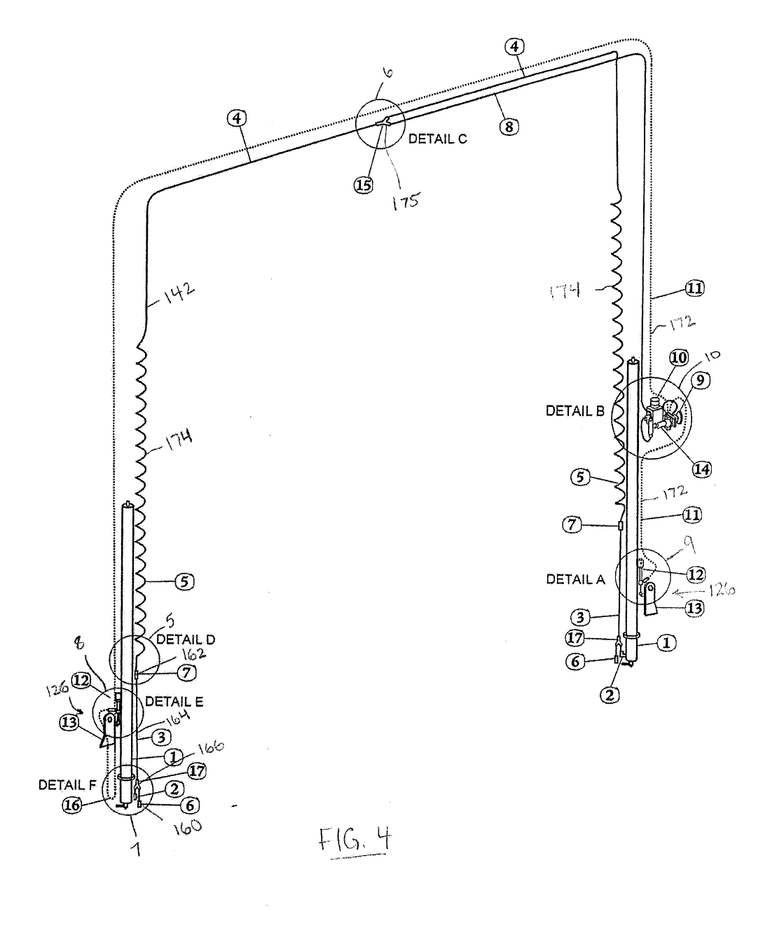

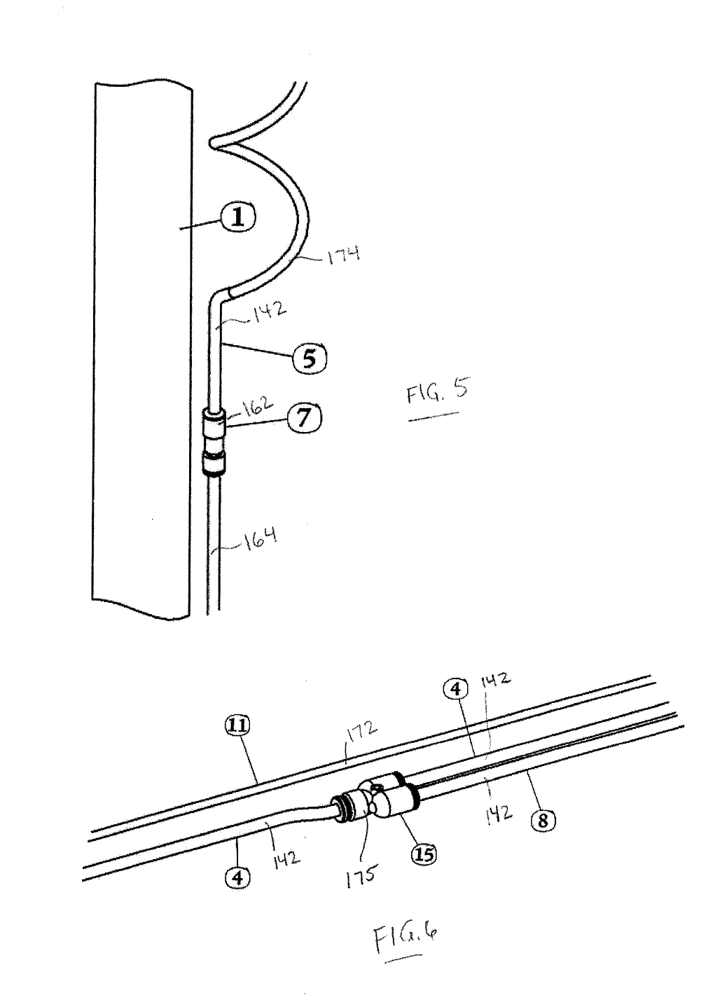

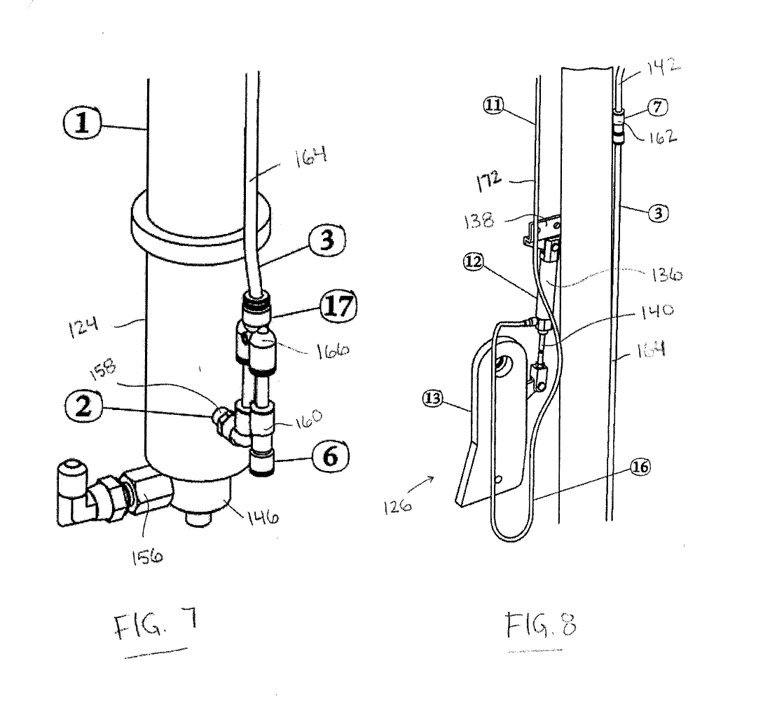

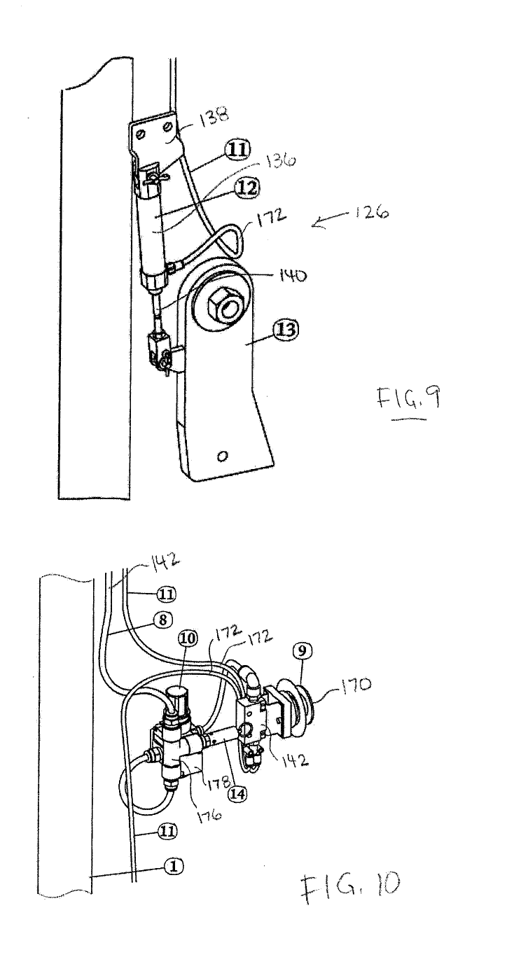

In the example shown, ratchet 130 is pivotally connected to load support 104 by a fastener 134. Ratchet 130 may be disengaged by rotating ratchet 130 about fastener 134 in a counterclockwise direction to allow load support 104 to be lowered. Reference is now made to FIGS. 3-10. As shown, mechanical lock 126 may be a pneumatic lock including single-acting pneumatic cylinder 136 (see FIGS. 8 and 9). Pneumatic cylinder 136 includes a base 138 rigidly connected to load support 102 or 104 (not shown), and a piston rod 140 pivotally connected to ratchet 130. Mechanical lock 126 may be disengaged by energizing cylinder 136 with compressed gas (e.g. compressed air) from line 142 to withdraw piston rod 140 and rotate ratchet 130 in a counterclockwise direction.

The compressed gas to actuate mechanical locks 126 may be obtained by compressed gas supplies such as a pneumatic tank and/or a pneumatic compressor. However, such compressed gas supplies may introduce additional cost and complexity to lift 100. In the example shown, lift 100 includes a gas regeneration system, comprising hydraulic cylinders 124 and line 142, which generates and stores the compressed gas required to operate pneumatic mechanical locks 126 (and/or other pneumatic devices) and which does not require a compressor to generate the compressed gas or a pneumatic tank to store the compressed gas.

Mechanical lock 126 provides an example of a pneumatic lock suitably configured to halt the descent of a load support 102 or 104 when hydraulic cylinders 124 are not energized. In alternative embodiments, mechanical locks 126 may have another suitable construction. For example, mechanical lock 126 may comprise a pneumatically actuated pin biased to normally engage with one of a plurality of holes. In another example, mechanical lock 126 may comprise a pneumatically actuated valve biased to normally prevent liquid from exiting single-acting hydraulic cylinder 124.

Continuing to refer to FIGS. 3-10, each hydraulic cylinder 124 defines a fluid chamber 144, and includes a piston rod 146 that extends into fluid chamber 144 (see FIG. 3). Fluid chamber 144 is divided into a liquid chamber 148 and a gas chamber 150. In the example shown, piston rod 146 includes an end seal 152 that separates liquid chamber 148 from gas chamber 150.

Liquid chamber 148 includes a liquid port 154 that provides an inlet for injecting liquid (e.g. oil, or water) to energize hydraulic cylinder 124, and an outlet for liquid to exit from liquid chamber 148. In the example shown, piston rod 146 is hollow and liquid port 154 is positioned at an end of piston rod 146. Piston rod 146 includes a liquid port 156 for connecting with a liquid reservoir (not shown, e.g. an oil reservoir). Liquid can pass through piston rod 146 to flow between liquid chamber 148 and the connected liquid reservoir. In alternative embodiments, liquid port 154 may be positioned on a different wall of liquid chamber 148 and connect directly with the liquid reservoir. In this case, piston rod 146 may have a solid cross-section (i.e. not hollow). In some embodiments, liquid chamber 148 includes separate inlet and outlet liquid ports instead of one liquid port that provides alternately an inlet or outlet.

Gas chamber 150 includes a gas port 158. Check valves 160 and 162 are connected to gas port 158 by pneumatic line 164 to direct the flow of gas that moves into and out of gas chamber 150. Pneumatic line 164 includes a T-fitting 166. As used herein and in the claims, “a pneumatic line” means one hose, pipe or other conduit suitable for transmitting gas, or a plurality of hoses, pipes, and/or other conduits which in combination provide a contiguous internal volume. As shown, check valve 160 connects line 164 with atmospheric air. In alternative examples, check valve 160 connects line 164 with another low-pressure (e.g. ambient pressure) gas source. Check valve 162 connects line 164 with pneumatic line 142. In alternative embodiments, gas chamber 150 includes separate inlet and outlet gas ports instead of one gas port 158 providing both an inlet and an outlet. In that case, check valve 160 may be connected to the inlet gas port, and check valve 162 may be connected to the outlet gas port.

The division of fluid chamber 144 between liquid chamber 148 and gas chamber 150 shifts when there is relative movement between piston rod 146 (with end seal 152) and fluid chamber 144. In the example shown, piston rod 146 is stationary, and energizing hydraulic cylinder 124 moves fluid chamber 144 relative to piston rod 146. In alternative embodiments, fluid chamber 144 is stationary, and energizing hydraulic cylinder 124 moves piston rod 146 relative to fluid chamber 144. Energizing hydraulic cylinder 124 extends hydraulic cylinder 124 which increases the volume of liquid chamber 148 and decreases the volume of gas chamber 150. Similarly, when hydraulic cylinder 124 is not energized and hydraulic cylinder 124 retracts, the volume of liquid chamber 148 decreases and the volume of gas chamber 150 increases. As used herein and in the claims “energizing” a hydraulic cylinder means to inject liquid into the liquid chamber of that hydraulic cylinder.

In alternative embodiments, liquid chamber 148 and gas chamber 150 may be reversed, such that extending hydraulic cylinder 124 increases the volume of gas chamber 150 and retracting hydraulic cylinder 124 decreases the volume of gas chamber 150. In either case, energizing hydraulic cylinder 124 increases the volume of liquid chamber 148 and decreases the volume of gas chamber 150.

When the volume of gas chamber 150 increases, the gas inside expands to occupy the enlarged volume and a vacuum pressure develops in gas chamber 150 and line 164. The vacuum pressure in line 164 opens check valve 160 which allows gas (e.g. ambient air) to flow through check valve 160 into gas chamber 150. The vacuum pressure also keeps check valve 162 closed which prevents pressurized gas from entering gas chamber 150 from line 142.

When the volume of gas chamber 150 decreases, the gas inside compresses to conform to the reduced volume and a positive pressure develops in gas chamber 150 and line 164. The positive pressure opens check valve 162 evacuating compressed gas from gas chamber 150 into line 142. The positive pressure also keeps check valve 160 closed, which prevents gas in gas chamber 150 from venting through check valve 160.

Check valves 160 and 162 are examples of flow control devices which alternately allow low pressure air to enter gas chamber 150 and allow compressed air from gas chamber 150 to enter line 142.

Line 142 accumulates compressed gas each time hydraulic cylinder 124 is energized and the volume of gas chamber is reduced. Check valve 162 opens when the gas pressure in line 164 exceeds the gas pressure in line 142 by a threshold amount. When check valve 162 is open, the pressure gradient between lines 164 and 142 induces a flow of gas from line 164 to line 142. Line 142 may conveniently act as both a storage facility for compressed gas and a conduit to deliver compressed gas to pneumatic devices, such as pneumatic mechanical locks 126.

As shown, line 142 is connected to a manually-actuated pneumatic valve 168 which controls the compressed air supply to pneumatic mechanical locks 126. Pneumatic valve 168 is normally closed and includes a button 170 to open. When pneumatic valve 168 is opened, compressed gas from line 142 is allowed to flow through pneumatic valve 168 and pneumatic lines 172 to pneumatic mechanical locks 126. As explained earlier, the supply of compressed gas retracts pneumatic cylinders 136 and disengages pneumatic mechanical locks 126, which allows hydraulic cylinders 124 to retract. When pneumatic valve 168 is closed, such as by releasing button 170, the remaining compressed gas, if any, in line 142 is sealed inside line 142 (e.g. for subsequent use).

In the example shown, both lines 164 connect to a common line 142. In this configuration, the gas compressed by both hydraulic cylinders 124 is stored in the same line 142. As best seen in FIGS. 1 and 4, line 142 is routed up through vertical columns 116 and 118, and across a cross-beam 172. This may prevent interference with line 142 by, e.g. tires of a car vehicle. In alternative embodiments, line 142 extends across the floor (not shown) instead of across cross-beam 172.

In the example shown, gas ports 158 are positioned on a mobile portion (fluid chamber 144) of hydraulic cylinder 124. When hydraulic cylinder 124 extends, the path length between gas ports 158, across cross-beam 172, decreases and vice versa. Line 142 includes coiled portions 174 to account for the changes in path length. Coiled portions 174 automatically extend and contract in response to increases and decreases in the path length between gas ports 158. Alternatively or in addition, line 142 and/or line 164 may include slack or pulleys to accommodate changes in path length. In further alternatives, gas ports 158 may be positioned on a stationary portion of hydraulic cylinder 124, such that the path length between gas ports 158 remains constant. For example, fluid chamber 144 may be stationary and instead piston rod 146 may be mobile.

In the example shown, line 164 is also connected with a pressure relief valve 176, and a pressure regulator 178. Pressure relief valve 176 is configured to open and vent gas from line 142 when the gas pressure inside rises above a threshold value (e.g. 200 psi). This may prevent line 142 from developing excessive gas pressures which may otherwise cause line 142 to fail (e.g. explode or develop a leak). Pressure regulator 178 is configured to provide a constant downstream pressure (e.g. 35 psi). In alternative embodiments, lift 100 may not include one or both of pressure relief valve 176 and pressure regulator 178.

Both lines 164 are shown connected to a common line 142. As shown, the portions of line 142 which connect to each line 164 and to pneumatic valve 168 are joined by a T-fitting 175. In alternative embodiments, each line 164 may connect to a different line 142, and each line 142 may connect to a different pneumatic valve 168. Applied to the example shown, this may provide two independent gas regeneration systems (one for each hydraulic cylinder 124), instead of one gas regeneration system including two hydraulic cylinders as shown.

Hydraulic cylinder 124 may require some additional energy to operate in comparison with a traditional single-acting hydraulic cylinder, in which the gas chamber is open to atmospheric air. The additional energy requirement derives from the compression of gas in gas chamber 150 which supplies line 142. In effect, hydraulic cylinder 124 acts as both a single-acting hydraulic cylinder and an air compressor. In turn, line 142 may acts as both a storage facility for compressed gas and a conduit for delivering compressed gas to pneumatic devices.

It will be appreciated that lift 100 is but one example application of the gas regeneration system herein described. A gas regeneration system including hydraulic cylinder 124 and line 142 may be broadly applicable to many other applications in which a single-acting hydraulic cylinder and compressed air is required. For example, line 142 may supply compressed air to any one or more pneumatic devices such as pneumatic tools (e.g. drills, grinders, and nail guns), spray guns (e.g. for paint or other liquids), switches, valves and brakes. As does the gas regeneration system in lift 100, a broadly applicable gas regeneration system may include a plurality of interconnected hydraulic cylinders 124 which exhaust compressed air to a common line 142. Further line 142 may be in fluid communication with one or more flow control devices, such as check valves 160 and 162, which direct the flow of gas between hydraulic cylinder 124, a low-pressure gas source, and line 142.

The gas regeneration system may provide an effective means of generating and storing compressed air using a single-acting hydraulic cylinder, which avoids the cost and complexity of a pneumatic tank, a compressor or a dedicated external compressed air supply (“shop air”).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A hydraulic lift comprising:
a hydraulic cylinder defining a fluid chamber, the hydraulic cylinder having
a piston rod extending into the fluid chamber,
a seal dividing the fluid chamber into a liquid chamber and a gas chamber, and
a gas outlet from the gas chamber;
a pneumatic line in fluid communication with the gas outlet, the line accumulating gas that is compressed in the gas chamber when the hydraulic cylinder is energized; and
a load support for carrying a load and coupled to the hydraulic cylinder such that energizing the hydraulic cylinder raises the load support,
the hydraulic lift being free of pneumatic tanks for compressed gas storage.

2. The hydraulic lift of claim 1, further comprising
a pneumatic mechanical lock normally engaged to prevent the load support from lowering,
the mechanical lock being operable using the compressed gas accumulated in the line to disengage the mechanical lock.

3. The hydraulic lift of claim 2, further comprising
a valve fluidly coupled to the line and to the mechanical lock, the valve selectively fluidly coupling the line and the mechanical for providing compressed gas accumulated in the line to the mechanical lock to disengage the mechanical lock.

4. The hydraulic lift of claim 1, further comprising
a flow control device in communication with the line, the flow control device preventing gas flow from the line into the gas chamber and permitting gas flow from the gas chamber into the line.

5. The hydraulic lift of claim 1, wherein
the gas chamber includes a gas inlet, and
the piston rod is movable into or out of the fluid chamber to enlarge the gas chamber and draw gas into the gas chamber through the gas inlet.

6. The hydraulic lift of claim 5, further comprising
a flow control device in fluid communication with the gas inlet, the flow control device preventing gas flow from the gas chamber through the gas inlet and permitting gas flow through the gas inlet into the gas chamber.

7. The hydraulic lift of claim 1, further comprising
a second hydraulic cylinder defining a second fluid chamber, the second hydraulic cylinder having
a second piston rod extending into the second fluid chamber,
a second seal dividing the second fluid chamber into a second liquid chamber and a second gas chamber, and
a second gas outlet from the second gas chamber;
a second load support for carrying the load and coupled to the second hydraulic cylinder such that energizing the hydraulic cylinder raises the second load support,
the line being in fluid communication with the second gas outlet, the line accumulating gas that is compressed in the second gas chamber when the second hydraulic cylinder is energized.

8. A gas regeneration system comprising:
a hydraulic cylinder defining a fluid chamber, the hydraulic cylinder having
a piston rod extending into the fluid chamber,
a seal dividing the fluid chamber into a liquid chamber and a gas chamber, and
a gas outlet from the gas chamber; and
a pneumatic line in fluid communication with the gas outlet, the line accumulating gas that is compressed in the gas chamber when the hydraulic cylinder is energized;
the system operating without a pneumatic tank for compressed gas storage.

9. The system of claim 8, further comprising
a pneumatic device in fluid communication with the line for receiving the compressed gas accumulated in the line.

10. The system of claim 8, wherein
the seal is connected to the piston rod.

11. The system of claim 8, further comprising
a flow control device in communication with the line, the flow control device preventing gas flow from the line into the gas chamber and permitting gas flow from the gas chamber into the line.

12. The system of claim 8, further comprising
a valve fluidly coupled to the line and a pneumatic device, the valve selectively fluidly coupling the line and the pneumatic device for providing compressed gas accumulated in the line to the pneumatic device.

13. The system of claim 10, wherein
energizing the hydraulic cylinder moves the piston rod and decreases the volume of the gas chamber, which compresses the gas in the gas chamber and induces the compressed gas to flow through the gas outlet into the line.

14. The system of claim 10, wherein
the gas chamber includes a gas inlet, and
the piston rod is movable into or out of the fluid chamber to enlarge the gas chamber and draw gas into the gas chamber through the gas inlet.

15. The system of claim 14, further comprising
a flow control device in fluid communication with the gas inlet, the flow control device preventing gas flow from the gas chamber through the gas inlet and permitting gas flow through the gas inlet into the gas chamber.

16. The system of claim 8, further comprising
a second hydraulic cylinder defining a second fluid chamber, the second hydraulic cylinder having
a second piston rod extending into the second fluid chamber,
a second seal dividing the second fluid chamber into a second liquid chamber and a second gas chamber, and
a second gas outlet from the second gas chamber;
the line being in fluid communication with the second gas outlet, the line accumulating gas that is compressed in the second gas chamber when the second hydraulic cylinder is energized.

17. The system of claim 9, wherein
the pneumatic device is a pneumatically actuated mechanical lock.

18. A method of regenerating gas from a hydraulic cylinder, the hydraulic cylinder defining a fluid chamber, the hydraulic cylinder having a seal dividing the fluid chamber into a liquid chamber and a gas chamber, the method comprising:
energizing the hydraulic cylinder;
accumulating gas in a pneumatic line that is compressed in the gas chamber when the hydraulic cylinder is energized; and
providing the compressed gas accumulated in the line to a pneumatic device, the compressed gas never having been stored in a pneumatic tank.

19. The method of claim 18, further comprising
drawing gas into the gas chamber through a gas inlet in the gas chamber.

20. The method of claim 18, wherein
providing the compressed gas accumulated in the line to a pneumatic device comprises providing the compressed gas accumulated in the line to a pneumatic mechanical lock to disengage the mechanical lock.
